(19) United States
(12) Patent Application Publication
(10) Pub. No.: US 2013/0320917 A1
(43) Pub. Date: Dec. 5, 2013

(54) Mobile Power Device with Projection

(71) Applicant: Ji Yu SIE, Taipei City (TW)

(72) Inventor: Ji Yu SIE, Taipei City (TW)

(21) Appl. No.: 13/909,762

(22) Filed: Jun. 4, 2013

(30) Foreign Application Priority Data
Jun. 5, 2012 (TW) 101210833

(51) Int. Cl. H02J 7/00

(52) U.S. Cl. CPC H02J 7/0042
USPC 320/107

(57) ABSTRACT

The creation provides a kind of project function for the mobile power device, which including control circuit boards, power contact tools, charging the battery units; Both of the power connecter tools and the battery charging units that connect control circuit board to charge and discharge the power so that it can works fluently. The micro-projection which including micro-projection modules and micro-projection lens; the signal, however, is also can delivery elements and messages to control the circuit board. Therefore, this mobile power device creation which with projection functions, it can provide other electric devices to charge and with delivery signal the electric devices of others to the micro-projection device, making the function of project.

### BACKGROUND OF THE INVENTION

1. Field of Invention

The creation provides a kind of project function for the mobile power device; especially for those structures which composed of easy to take, and this mobile power device creation which also with projection function, it can provide other electric devices to charge as emergency power supply, and it also can provide others electric devices to making the function of projection.

2. Description of the Related Art

Nowadays, owing to the electric product, the internet, and the community technology update continually, which make smart phones, tablet computers, MP3 or MP4, PDA and so on; these variety of consumer electronics become very common, so people will take many mobile electric products and use the more and more powerful function of the mobile electric products surfing the internet, watching the video, listening to the music, taking pictures and playing games, etc.

However, these the same feature of the mobile electric products that is all of them will use the secondary battery, which always bring to the question about off power when people go outside; besides, because limiting of electric products designed, people could not change the secondary battery to that much higher capacity one, this problem often causes extremely inconvenient, whom demand having no choice but charging the battery.

Therefore, there are some designs for mobile devices (Power Bank) which is solving the battery of mobile devices are shortage, By designing for high capacity that can make the customer charging mobile devices in advance, even people are in outside who could charge their mobile devices.

Nevertheless, the function of the traditional mobile device only can charge and discharge, there are no much more advantages to our customers; therefore, the electronic product is hard to satisfy the demand of our customers. Besides, the functions of the consuming electronic product is getting more and much stronger, which almost cancan play videos and pictures s, it couldn't promote technology industry to go further develop if the mobile device not promoted active.

Therefore, how to create a mobile device, not only charging the consuming electronic product, but making the consuming electronic product that can generally play videos and pictures, this creation will be that people who want to know.

### 3. SUMMARY OF INVENTION

According to the shortage of technology knowledge, the creator considered that the mobile device is not good enough, the creator further to invent a project function for the mobile power device to reach the goal that could charge, discharge, and project videos.

To reaching the above goal, the creation is with the project function of the practice contents to the mobile power device as following,

A project function for the mobile power device, including:
The board of power controlling, the control circuit board to charge and discharge the power.
The power connect tools, which connect control circuit board to charge and discharge the power so that it can works fluently.
Charging the battery units, the charging the battery units at least involved a charging battery, it can control the connecting of the circuit board, being making sure that this charging battery should be charged or discharged.

Micro-projection device, the micro-projection which including micro-projection modules and micro-projection lens, the micro-projection modules should be packaged with micro-projection modules and a signal delivery tool; both of the signal source delivery too and control circuit board should be combined together and delivery messages.

According to the project function of the practice contents to the mobile power device, moreover, it including the body, circuit board, battery charge units; which make power connect tools and micro-projection lens of the device that can show out from the body.

According to the project function of the practice contents to the mobile power device, including the input power and output power, which the electronic pressure is 3.5˜21Volt (V), the electric current is 0.7˜11 Ampere (A).

According to the project function of the practice contents to the mobile power device, power connect tools combined with the connecter of the power circuit board.

According to the project function of the practice contents to the mobile power device, the power connecter is the USB power connecter.

According to the project function of the practice contents to the mobile power device, power connect tools connect the power line from the board of power controlling.

According to the project function of the practice contents to the mobile power device, the signal source tool is the power connecting of the signal source; and the signal line should be the integrated power line.

According to the project function of the practice contents to the mobile power device, the signal source delivery tools should connect with the delivery module of the circuit board.

According to the project function of the practice contents to the mobile power device, all the from the lithium battery, LFP, LiMn2O4 Prismatic Cells, alkaline battery and OXYRIDE.

### 4. BRIEF DESCRIPTION OF THE DRAWINGS

The invention will be described according to the appended drawings in which:

FIG. 1 is for three-dimensional perspective view illustrating conditions.

FIG. 2 is for device configuration schematic diagram.

FIG. 3 is for using condition reference.

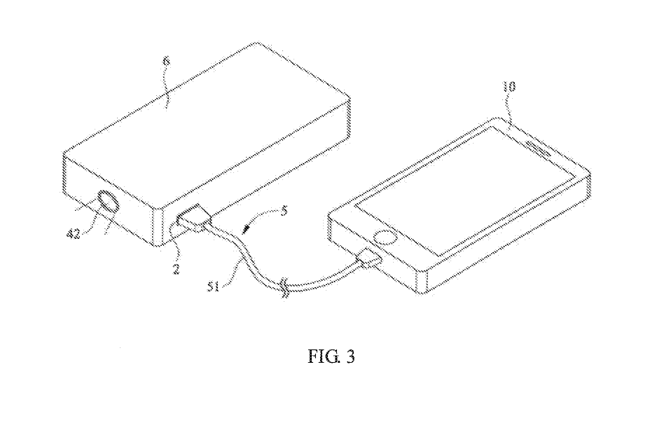

### 5. DETAILED DESCRIPTION OF THE INVENTION

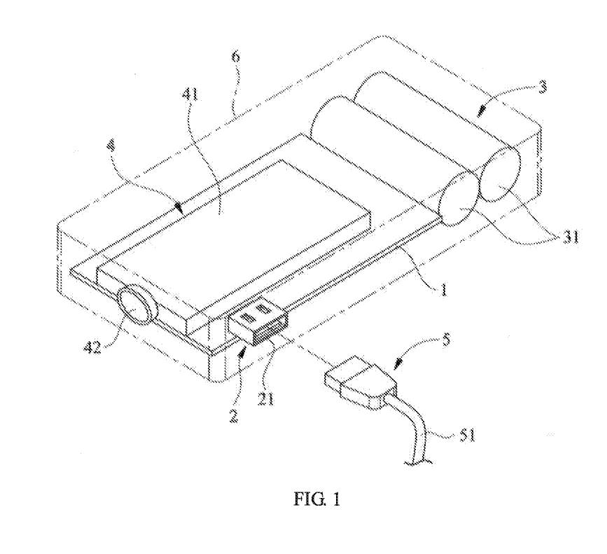

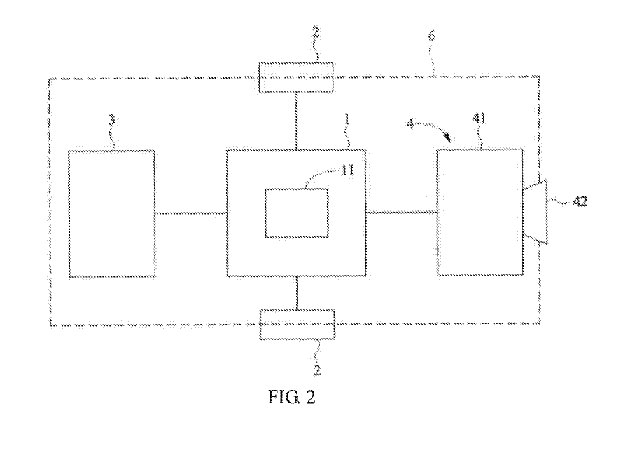

Reference from FIG. 1 and FIG. 2 as showing; the creation is with project function for the mobile power device, the much better cases including the board of power controlling 1, the power connect tools 2, battery charge units 3, the micro-projection device, signal delivery tools 5, packaging all of them and combined them in a body 6, which including as following:

By control the circuit board as 1. The creation provides of the mobile for power device with charge and discharge of the power and with necessary control monitor and electronic tools 2. Battery charge units 3. Micro-projection device 4.

Component 2 of the power connectors of electric charge and discharge circuit connected to the control circuit board 1, component 2 input power connections power to charge and discharge circuit and output supply for charging other portable electronic devices. Among other things, the power connection 2 is a combination electrical connector on the control circuit board 1 21, such as consumer electronics standard USB connector, through the USB connector for charging and discharging. However, component 2 of the power connectors are not are limited to implementation of electrical connectors, also contains a direct connection to the Control Board 1 power cord (no icon), using mains power cord connection for.

A rechargeable battery the rechargeable battery unit 3 contains at least 31 (as shown in the figure for the two 31 series or even a rechargeable battery), unit 3 and rechargeable batteries (rechargeable battery 31) electric charge and discharge circuit for connection to the above control circuit board 1 and 31 to a rechargeable battery capable of storing or releasing input power and output the power. The much better cases about the charging battery 3 which all from the lithium battery, LFP, LiMn2O4 Prismatic Cells, alkaline battery and OXYRIDE. Moreover, the much better the charging battery 3 that the total capacity is over 1000 mAh.

That signal 5 transmission components for connecting to the power supply module 2 signal line 51, line and 51 for integration-integration of the power cable wires, its better implementation of selection of USB signal lines. However, the signal transmission components 5 can choose to connect to the control circuit board 1 or 41 micro-projection modules wireless transmission module (not the icon). Thus, this creation to take advantage of the signal 1 5 transmission component and control circuit board or micro projection module 41 online send a video message (or other portable electronic devices of video signal source).

By the above 1. The power connect tool 2. Battery charge units 3, the 41 micro-projection module of the micro-projection device 4m is installed in the body 6, according to the reference about power connector tools 2 and signal source line of 51, and micro-projection lens 42 can make videos projection.

By the above controlling circuit board 1, the power connect tool 2, battery charge units 3, micro-projection device 4, signal delivery tools. 5, packaging all of them and combined them in a body 6, which the electronic pressure is 3.5˜21Volt (V), the electric current is 0.7˜11 Ampere (A), all fit for the common seen electronic mobile device, for example: Smart phones, tablet computers, note book, MP3 or MP4, PDA or digital cameras, etc.

When using project function for the mobile power device, this creative power unit used, route 51 2 mains connection power connection components or desktop (Notebook), such as computer and input power to a rechargeable battery unit 3, as for traveling to other portable electronic devices of standby power. As shown in the 3rd, when 10 other portable electronic devices (such as mobile phones) the lack of electricity, accessible through the signal line 51 connection to power portable electronic devices and components 2 10, to charge the portable electronic device 10 function, Furthermore, this author will also receive the portable electronic device 10 visual signals

As noted above, fully comply with this creation patented three elements: new, progressive and availability in the industry. In terms of novelty and progress, this creation is through the control circuit board, power supply components, rechargeable battery cell design components, micro-projection device and signal transmission, power unit of composition with the projection functions, thus can be used as power supply unit for charging and discharging, and possess the other portable electronic devices are projected to play feature, As far as the availability of the industry, the creation of structure and technology, can fully meet the current demands in the industry.

The above-described embodiments of the present invention are intended to be illustrative only. Numerous alternative embodiments may be devised by persons skilled in the art without departing from the scope of the following claims.

1. A mobile power device having a projection function, comprising:
The board of power controlling, the control circuit board to charge and discharge the power;
The power connect tools, which correct control circuit board to charge and discharge the power so that it can works fluently;
Charging the battery units; and
Micro-projection device, the micro-projection which including micro-projection modules and micro-projection lens, the micro-projection modules should be packaged with micro-projection modules and a signal delivery tool; both of the signal source delivery too and control circuit board should be combined together and delivery messages.

2. The mobile device having a projection function of claim 1, further comprising a body, the board of power controlling, battery charge units, the micro-projection modules of the micro-projection in a body, which make power connect tools and micro-projection lens of the device that can show out from the body.

3. The mobile power device having a projection function of claim 1, including the input power and output power, which the electronic pressure is 3.5˜21 Volt (V), the electric current is 0.7˜11 Ampere (A).

4. The mobile power device having a projection function of claim 1, further comprising power connect tools combined with the connecter of the power circuit board.

5. The mobile power device having a projection function of claim 1, wherein the power connecter is fit for mobile power device.

6. The mobile power device having a projection function of claim 1, further comprising power connect tools connect the power line from the board of power controlling.

7. The mobile power device having a projection function of claim 1, wherein the signal source tool is the power connecting of the signal source.

8. The mobile power device having a projection function of claim 7, wherein the signal line could be the integrated power line.

9. The mobile power device having a projection function of claim 1, wherein the signal source delivery tools connect to the circuit board to wireless transmission module.

10. The mobile power device having a projection function of claim 1, wherein the projection function for the mobile power device, all from the lithium battery, LFP, LiMn2O4 Prismatic Cells, alkaline battery and OXYRIDE.
